(19) United States
(12) Patent Application Publication
(10) Pub. No.: US 2026/0356180 A1
(43) Pub. Date: Nov. 12, 2026

(54) Machine Housing for a Machine Arrangement, Method of Manufacturing a Machine Arrangement and Machine Arrangement for a Motor Vehicle

(71) Applicant: Bayerische Motoren Werke Aktiengesellschaft, Muenchen (DE)

(72) Inventors: Egon PIBINGER, Pasching (AT); Mario PRANDSTOETTER, Linz (AT)

(21) Appl. No.: 19/117,138

(22) PCT Filed: Oct. 24, 2023
(86) PCT No.: PCT/EP2023/079556

§ 371 Date: Mar. 31, 2025

(30) Foreign Application Priority Data
Nov. 18, 2022 (DE) 10 2022 130 545.7

(51) Int. Cl. B60K 1/02; H02K 5/06; H02K 5/15; H02K 7/00; H02K 7/116

(52) U.S. Cl. CPC B60K 1/02; H02K 5/06; H02K 5/15; H02K 7/006; H02K 7/116

(57) ABSTRACT

A machine housing for a machine arrangement for driving a motor vehicle, which is designed to accommodate a first electric machine and at least one second electric machine and has a first machine housing segment and at least one second machine housing segment. The first machine housing segment comprises a first recess for inserting the first electric machine and the second machine housing segment, which is different from the first machine housing segment, comprises a second recess for receiving the second electric machine.

### BACKGROUND AND SUMMARY

The invention relates to a machine housing for a machine arrangement designed for driving a motor vehicle. Further aspects of the invention relate to a method of manufacturing a machine arrangement and to a motor vehicle with a machine arrangement.

Machine housings for drive machines or an arrangement for several drive machines, in short machine arrangements, serve, among other things, to protect sensitive components from environmental influences and to supply coolant and/or lubricant. For example, WO 2021/099034 A1 discloses a modular electric axle drive for vehicles, a manufacturing method for such a modular axle drive and an assembly method for a modular axle drive in a vehicle. A machine housing of an electric machine of the modular axle has a machine coolant channel. A transmission housing of a transmission of the modular axle has at least one transmission coolant channel. An electronics housing of a power electronics unit of the modular axle has at least one electronics coolant channel. The machine housing is mechanically connected to the transmission housing in a detachable manner on its drive side located at the front in the axial direction. The electronics housing is mechanically connected to the transmission housing and the machine housing in a detachable manner.

An object of the present invention is to provide a machine housing which enables a simplified method of manufacturing a machine arrangement with such a machine housing, as well as a motor vehicle with a corresponding machine arrangement.

This object is achieved by a machine housing having the features disclosed herein, by a method having the features disclosed herein, which serves to manufacture a machine arrangement comprising such a machine housing, and by a motor vehicle having the features disclosed herein. Advantageous embodiments with expedient developments of the invention can also be found in the present disclosure.

A first aspect of the invention relates to a machine housing for a machine arrangement designed to drive a motor vehicle, which is designed to accommodate a first E-machine and at least one second E-machine and has a first machine housing segment and at least one second machine housing segment.

According to the invention, it is provided that the first machine housing segment comprises a first recess for inserting the first E-machine and the second machine housing segment, which is different from the first machine housing segment, comprises a second recess for receiving the second E-machine. This is advantageous because the first E-machine and the second E-machine can thus each be inserted into the respective machine housing segment independently of one another, wherein the machine housing segments can in particular be designed as components of the machine housing that are different from one another. This generally enables simplified manufacture of both the machine housing and the machine arrangement, since the individual machine housing segments can be provided, the respective E-machines can be inserted and the machine housing segments fitted with the respective E-machines can finally be joined together during manufacture of the machine housing and/or the machine arrangement.

Preferably, the first machine housing segment and the second machine housing segment in the machine housing can be separated from one another by at least one gap. The gap can be delimited, in particular exclusively, by the first machine housing segment and the second machine housing segment. In the finished machine housing, the gap can be filled with a sealant, at least in some areas, which makes it possible to achieve a targeted, needs-based seal.

The first machine housing segment and second machine housing segment can preferably be designed as different cast parts from each other. This enables particularly low-cost production of the respective machine housing segments with reliably reproducible quality.

The first machine housing segment and the second machine housing segment can be reversibly detachably, in other words, non-destructively detachably, interconnected components of the machine housing. This makes it possible to easily replace one of the machine housing segments, for example during maintenance work. Preferably, the first machine housing segment and the second machine housing segment can be bolted together.

The first recess and additionally or alternatively the second recess can be hollow-cylindrical. This allows a particularly reliable, circumferential positional locking of the respective E-machine in the respective recess.

The invention is based on the realization that there are fundamental differences in respect of the assembly procedure for machine housing assemblies, depending on whether the respective machine housing assembly is designed to mount only one E-machine or several E-machines. In machine housing assemblies known from the prior art, which are designed to accommodate two E-machines, it is common practice to arrange both E-machines in adjacent recesses of a single housing part of the machine housing assembly, for example by inserting them into the recesses, which are usually designed as cylindrical bores. In order to ensure that the respective rotor shafts of the respective E-machines are oriented in different directions, one of the E-machines is usually first inserted into the corresponding recess, the housing part is rotated together with this E-machine and then the second E-machine is inserted into the remaining recess. In order to avoid any unwanted axial offset, the first E-machine to be inserted must be secured axially during rotation, for example by holding it in place. Once the E-machines have been inserted, it is common practice to close the two corresponding recesses with another housing part of the machine housing assembly in the form of a cover. The cover is usually used to close both recesses.

The proposed invention makes it possible, for example, to dispense with the axial securing of the first-assembled E-machine, thereby enabling simple assembly and thus a simplified method of manufacturing a machine arrangement.

In an advantageous development of the invention, the first machine housing segment and the second machine housing segment overlap in at least two different spatial directions. This is advantageous, since the overlap in at least two different spatial directions enables the machine housing segments to be mutually braced against each other and thus ensures an exact alignment of the machine housing segments relative to one another. Preferably, the machine housing can overlap at least in a direction parallel to the respective central axis of the first recess and/or the second recess, whereby a particularly precise axial alignment of the E-machines to be accommodated or already accommodated in the respective recesses is made possible.

In a further advantageous development of the invention, the first machine housing segment and the second machine housing segment are reversibly detachably connected to one another. This is advantageous because it allows one of the machine housing segments be replaced and the other machine housing segment to continue to be used, for example during repair or maintenance work, thereby saving resources. In the present case, the term “reversibly detachably connected” means that the machine housing segments can be detachably connected to each other in a non-destructive manner, for example by being bolted together.

In a further advantageous development of the invention, the first machine housing segment and the second machine housing segment are designed as respective cast parts. This advantageously permits low-cost high-quality reproducible manufacture of the machine housing segments. In addition, cast parts have particularly good vaporization properties, whereby favorable acoustic properties of the machine arrangement can be achieved.

In a further advantageous development of the invention, one of the machine housing segments in each case has an end shield for the E-machine to be mounted in the other machine housing segment. This is advantageous because the respective machine housing segment thus has increased functionality and fewer individual parts have to be connected to each other during assembly. In other words, the first machine housing segment can therefore have a first end shield for the second E-machine to be mounted in the second machine housing segment, whereas the second machine housing segment can have a second end shield for the first E-machine to be mounted in the first machine housing segment.

In a further advantageous development of the invention, the first machine housing segment has a first sealing surface region and the second machine housing segment has a second sealing surface region, which together form a circumferential sealing surface when the machine housing segments are connected as intended. This is advantageous, as the joint formation of the circumferential sealing surface provides a means of aligning the machine housing segments flush with one another. By arranging the respective sealing surface regions in a common plane, it can be ensured that the corresponding machine housing segments and thus, for example, their respective recesses are also positioned correctly in relation to each other. The first sealing surface region and the second sealing surface region can form two gaps with each other when the machine housing segments are connected to each other, at which gaps the circumferential sealing contact surface can be interrupted.

In a further advantageous development of the invention, at least one of the machine housing segments has at least one transmission housing part for receiving a transmission shaft which can be driven by at least one of the E-machines. This is advantageous, as the functionality of the respective machine housing segments can be further improved as a result, whereby fewer individual parts have to be connected to one another when assembling the machine housing or the machine arrangement. The transmission shaft can be designed as an intermediate gear shaft, for example. The transmission housing part can preferably be shell-shaped. In other words, the transmission housing part can be designed as a transmission housing shell. The design as such a shell is particularly advantageous, since covering the transmission housing shell with a further shell element (shell-shaped element) can easily create a receiving space for a transmission.

A second aspect of the invention relates to a method of manufacturing a machine arrangement with a machine housing according to the first aspect of the invention. The method comprises at least the following steps:
providing the first machine housing segment, the second machine housing segment, the first E-machine and the second E-machine;
inserting the first E-machine into the first machine housing segment and thereby producing a first E-machine-machine housing segment assembly;
inserting the second E-machine into the second machine housing segment and thereby producing a second E-machine-machine housing segment assembly;
rotating at least one of the E-machine-machine housing segment assemblies relative to the other E-machine-machine housing segment assemblies; and
joining the first E-machine-machine housing segment assembly and the second E-machine-machine housing segment assembly, thus completing the machine arrangement and machine housing.

This method means, for example, that the axial securing of the first-mounted E-machine can be omitted during the assembly of the subsequently mounted E-machine, thus enabling simple assembly and simplified manufacture of the machine arrangement.

In an advantageous development of the invention, the first E-machine is inserted into the first machine housing segment along a first insertion direction and the second E-machine is inserted into the second machine housing segment along a second insertion direction oriented at least substantially in the same direction as the first insertion direction. This is advantageous, since the respective E-machines can thus be joined with the respective machine housing segments from the same direction, so to speak. This eliminates, for example, the need to pivot or tilt at least one of the E-machines before it is mounted on the corresponding machine housing segment. The first insertion direction and the second insertion direction can preferably be oriented parallel to each other. In the context of the present disclosure, the term “oriented at least substantially in the same direction” is to be understood as meaning that the first insertion direction and the second insertion direction enclose an angle of less than 45°, preferably less than 15° and particularly preferably less than 5° with one another.

A third aspect of the invention relates to a motor vehicle with a machine arrangement which is manufactured by a method according to the second aspect of the invention and/or has a machine housing according to the first aspect of the invention. Such a motor vehicle can be manufactured with a particularly low outlay.

The preferred embodiments presented in relation to one of the aspects and their advantages apply correspondingly the other aspects of the invention and vice versa.

The features and combinations of features mentioned above in the description as well as the features and combinations of features mentioned below in the description of the figures and/or shown alone in the figures can be used not only in the combination indicated in each case, but also in other combinations or on their own, without departing from the scope of the invention.

Further advantages, features and details of the invention can be found in the claims, the following description of preferred embodiments and the drawings.

In the following, the invention is explained once again with reference to a specific example.

### BRIEF DESCRIPTION OF THE DRAWINGS

FIG. 1 is a schematic perspective view of a machine housing assembly known from the prior art;

FIG. 2 is a schematic perspective view of a first machine housing segment of a machine housing for a variant of a machine arrangement;

FIG. 3 is a schematic perspective view of a second machine housing segment of the machine housing of the variant of the machine arrangement;

FIG. 4 is a schematic perspective view of the machine housing;

FIG. 5 is a schematic plan view of the first machine housing segment and the second machine housing segment, wherein both machine housing segments are oriented relative to each other in such a way that a first E-machine of the machine arrangement can be inserted along a first insertion direction into a first recess of the first machine housing segment and a second E-machine of the machine arrangement can be inserted along a second insertion direction oriented parallel to the first insertion direction into a second recess of the second machine housing segment;

FIG. 6 shows a further schematic plan view of the machine housing segments, wherein the second machine housing segment together with the second E-machine inserted into the second recess is rotated relative to the first machine housing segment and the first E-machine inserted into the first recess in a method of manufacturing the machine arrangement with the machine housing; and

FIG. 7 is a schematic plan view of the machine arrangement.

### DETAILED DESCRIPTION OF THE DRAWINGS

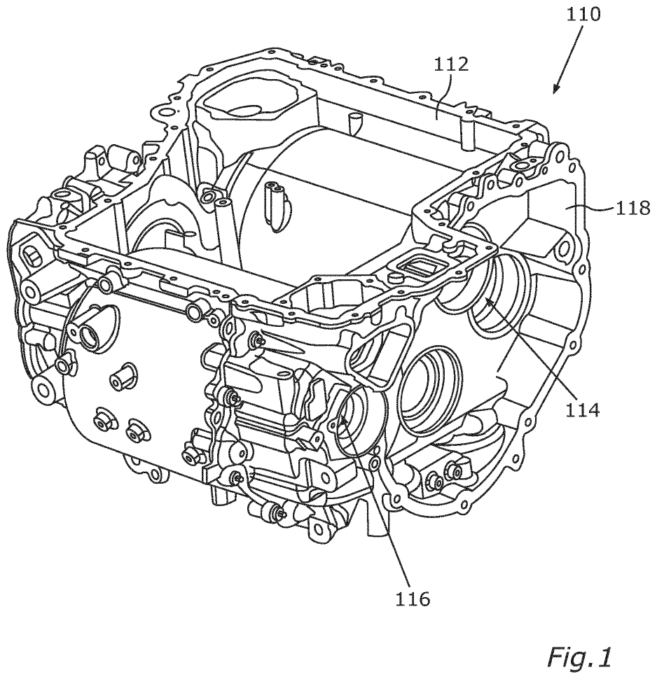

FIG. 1 shows an example of a machine housing assembly 110 known from the prior art, in which two electric machines, not shown further, hereinafter abbreviated as E-machines, are accommodated. Both E-machines are arranged in adjacent recesses 114, 116 of a single first housing part 112 of the machine housing assembly 110. The recesses 114, 116 are designed as cylindrical bores and are therefore, as can be seen in FIG. 1, delimited by correspondingly cylindrical housing walls. In order for the respective rotor shafts of the respective E-machines to be oriented in different directions, one of the E-machines is usually first inserted into the corresponding recess 114, 116, the housing part 112 is rotated together with this E-machine and then the second E-machine is inserted into the remaining one of the recesses 114, 116. In order to avoid any undesired axial offset, the first E-machine to be inserted must be secured axially during rotation, for example by holding it in place. After completion of the insertion of the E-machines, it is usual to close the two corresponding recesses 114, 116 with a further, second housing part 118 of the machine housing assembly in the form of a cover, whereby the recesses 114, 116 are predominantly covered by the second housing part 118.

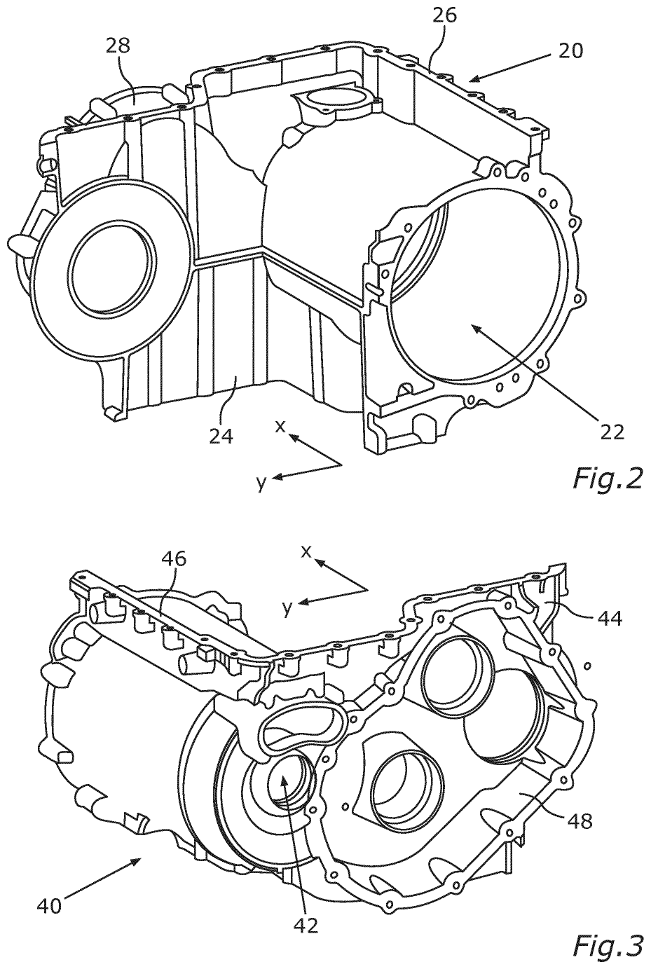

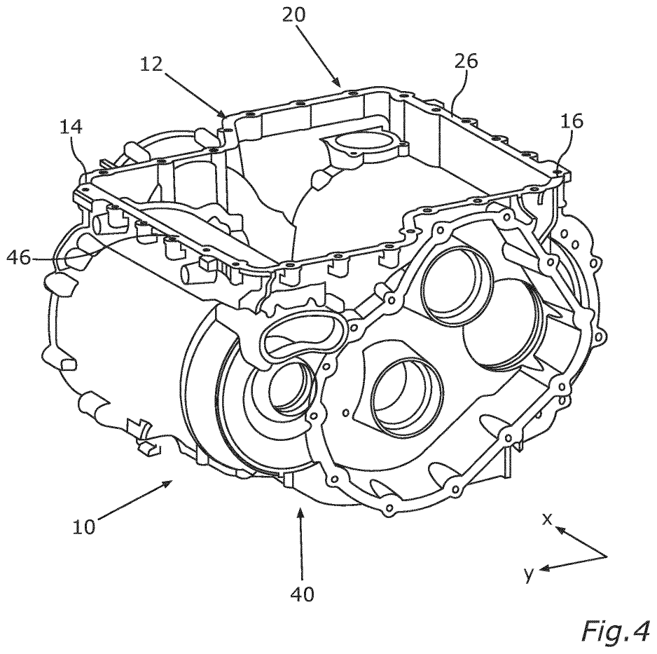

FIG. 2 shows a schematic perspective view of a first machine housing segment 20 and FIG. 3 a schematic perspective view of a second machine housing segment 40 for a machine housing 10 shown in FIG. 4. The first machine housing segment 20 and the second machine housing segment 40 are designed in the present case as respective, in particular metallic, cast parts.

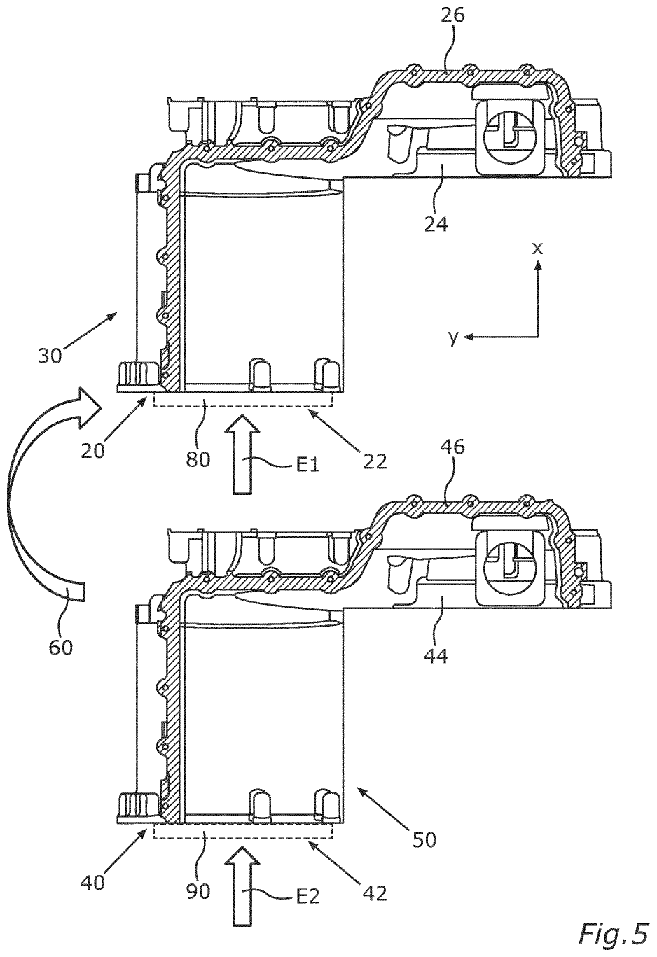

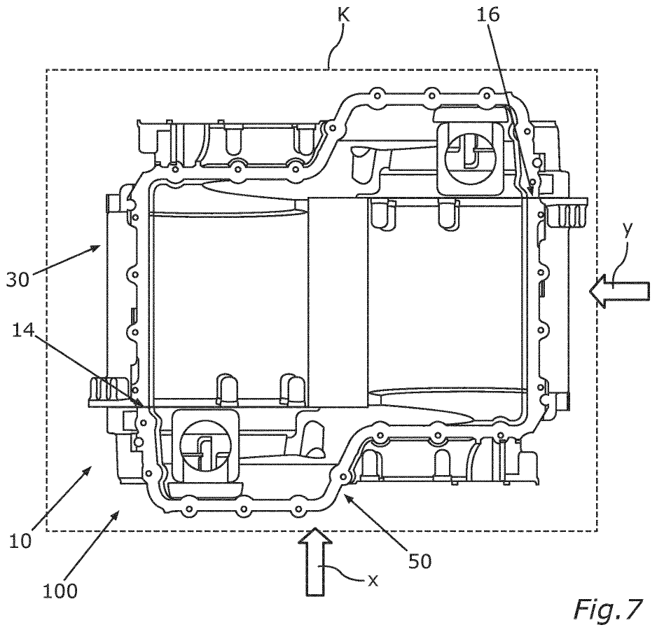

The first machine housing segment 20 has a first recess 22 for inserting a first E-machine 80, which is only shown schematically in FIG. 5. The second machine housing segment 40, which is different from the first machine housing segment 20, has a second recess 42 for receiving a second E-machine 90, which is also shown schematically in FIG. 5. The two E-machines 80, 90 can also be referred to as electric drive machines. The E-machines 80, 90 are used to drive a motor vehicle K, which is shown in a highly abstracted form in FIG. 7 for reasons of clarity.

The machine housing 10 comprising the two machine housing segments 20, 40, which is shown in schematic perspective view in FIG. 4, is a component of a machine arrangement 100 serving as the drive unit of the motor vehicle K in FIG. 7. In other words, the machine arrangement 100 thus comprises as a whole at least the machine housing 10 and additionally the E-machines 80, 90 arranged in the respective machine housing segments 20, 40 or in their recesses 32, 42.

A combined view of FIG. 2, FIG. 3 and FIG. 4 makes it clear that the first machine housing segment 20 and the second machine housing segment 40 in the machine housing 10 shown in FIG. 4 are located in at least two different spatial directions x, y, i.e., a first spatial direction x and a second spatial direction y, which together span a plane.

The first machine housing segment 20 and the second machine housing segment 40 are bolted together in the present case and are thus reversibly detachably connected to one another.

FIG. 2, FIG. 3 and FIG. 5 illustrate that the first machine housing segment 20 has a first end shield 24 for the E-machine 90 to be stored in the second machine housing segment 40. The second machine housing segment 40, on the other hand, has a second end shield 44 for the E-machine 80 to be stored in the first machine housing segment 20. When assembling the machine arrangement 100, the first end shield 24 thus serves to support a rotor shaft of the second E-machine 90, which is not shown here, and also protects the second E-machine 90 from environmental influences. In contrast, the second end shield 44 serves to support a (second) rotor shaft of the first E-machine 80, which is also not shown further in the present case, and accordingly protects the first E-machine 80 from environmental influences.

It can also be seen from a combined view of FIG. 2, FIG. 3 and FIG. 4 that the first machine housing segment 20 has a first sealing surface region 26 and the second machine housing segment 40 has a second sealing surface region 46, which, when the machine housing segments 20, 40 are connected to the machine housing 10 as intended, together form a circumferential sealing surface 12, which are separated from one another only at corresponding separation points of the machine housing segments 20, 40 by a first gap 14 and a second gap 16.

FIG. 2, FIG. 3 and FIG. 5 also show that the first machine housing segment 20 has a first transmission housing part 28 and the second machine housing segment 40 has a (second) transmission housing part 48. The respective transmission housing parts 28, 48 serve to accommodate a transmission shaft which can be driven by the respective E-machines 80, 90, but which is not shown further in the present case.

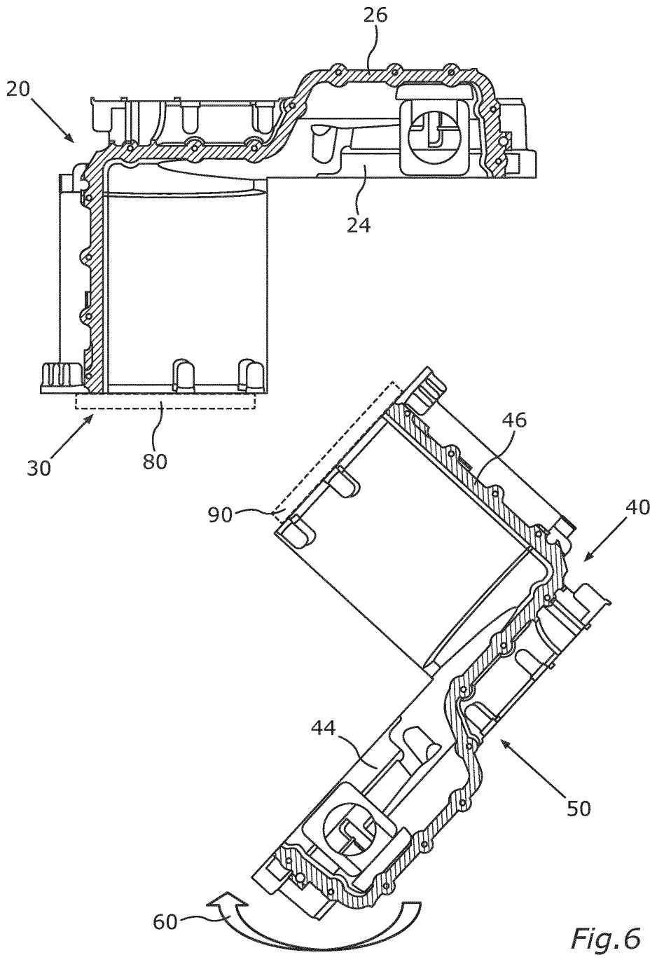

The machine arrangement 100 is manufactured according to a method which is described below with reference to FIG. 5 and FIG. 6 and comprises at least the following steps:

First, the first machine housing segment 20, the second machine housing segment 40, the first E-machine 80 and the second E-machine 90 are provided.

The first E-machine 80 is then inserted into the first machine housing segment 20, thereby producing a first E-machine-machine housing segment assembly 30.

In addition, the second E-machine 90 is inserted into the second machine housing segment 40, thereby producing a second E-machine-machine housing segment assembly 50. The first E-machine 80 is inserted into the first machine housing segment 20 along a first insertion direction El and the second E-machine 90 is inserted into the second machine housing segment 40 along a second insertion direction E2 oriented in the same direction and thus parallel to the first insertion direction E1.

The first E-machine-machine housing segment assembly 30 and the second E machine-machine housing segment assembly 50 are shown schematically in FIG. 5, wherein the E-machines 80, 90 inserted into the respective recesses 22, 42 are recognizable and protrude slightly from the respective recesses 22, 42.

In a further method step, a rotation 60 takes place, which is illustrated by a curved arrow in FIG. 5 and FIG. 6. During this rotation 60, one of the E-machine-machine housing assemblies 30, 50 is rotated relative to the other E machine-machine housing segment assembly 50, 30. In the present example, the second E-machine-machine housing segment assembly 50 is rotated relative to the first E machine-machine housing segment assembly 30.

This is followed by a joining of the first E-machine-machine housing segment assembly 30 and the second E-machine-machine housing segment assembly 50, whereby the machine arrangement 100 and the machine housing 10 are completed. During this joining operation, the gaps 14, 16 can be filled with a sealant and thereby sealed. This allows the circumferential sealing surface 12 to be closed. When installing the machine arrangement 100 in the motor vehicle K, a further vehicle component can be brought up to the sealing surface 12 and a sealing element can be arranged and/or clamped between the sealing surface 12 and this vehicle component, for example to prevent dirt from the environment from penetrating or lubricant from escaping between the sealing surface 12 and the component.

In summary, the present disclosure makes it possible for the two E-machines 80, 90, instead of being inserted into the respective recesses 114, 116 of the one-piece first housing part 112 known from the prior art, to be inserted into the two machine housing segments 20, 40, which are different from one another and which have respective end shields 24, 44. When the machine housing segments 20, 40 are arranged against one another as intended, the end shields 24, 44 lie opposite one another, preferably along a center axis (axis of rotation) of a rotor of at least one of the E-machines 80, 90.

The present disclosure makes it possible to overcome at least the following problem known from the prior art, according to which, when assembling systems known from the prior art, at least one of the E-machines must always be held in place after the E-machines have been joined in a housing before such an arrangement is turned over for further assembly operations, since only one of the E-machines is axially secured at this time.

This problem is overcome in the present disclosure. In addition, in the machine arrangement, respective shift rings assigned to the E-machines and not shown further in the present case can be larger in terms of their outer diameter than the respective inner diameter of the recesses 22, 42, as a result of which there is greater freedom of design, since the rotation 60 and the joining of the E-machine-machine housing segment assembly 30, 50 only takes place after the assembly of the E-machines 80, 90 in their respective recesses 22, 42.

In the systems known from the prior art, there is the restriction that a respective stator diameter must always be at least as large as the shift ring in question, as both E-machines must be inserted from the same side into the first housing part 112, also known as the central housing, and the inner diameter of the shift ring must always be at least as large as the rotor diameter of the respective E-machines, as in an E-machine the rotor must always be mountable through the shift ring. The present disclosure can always overcome either this restriction or the aforementioned problems.

### LIST OF REFERENCE SIGNS

10 machine house
12 circumferential sealing surface
14 first gap
16 second gap
20 first machine housing segment
22 first recess
24 first end shield
26 first sealing surface region
28 first transmission housing part
30 first E-machine-machine housing segment assembly
40 second machine housing segment
42 second recess
44 second end shield
46 second sealing surface region
48 second transmission housing part
50 second E-machine-machine housing segment assembly
60 rotation
80 first E-machine
90 second E-machine
100 machine arrangement
110 machine housing assembly
112 first housing part
114 first recess
116 second recess
118 second housing part
K motor vehicle
E1 first insertion direction
E2 second insertion direction
x first spatial direction
y second spatial direction

1-10. (canceled)

11. A machine housing for a machine arrangement configured to drive a motor vehicle, which is configured to accommodate a first E-machine and at least one second E-machine, the machine housing comprising:
a first machine housing segment and at least one second machine housing segment,
wherein the first machine housing segment comprises a first recess configured to receive the first E-machine, and
wherein the second machine housing segment, which is different from the first machine housing segment, comprises a second recess configured to receive the at least one second E-machine.

12. The machine housing according to claim 11,
wherein the first machine housing segment and the second machine housing segment overlap in at least two different spatial directions.

13. The machine housing according to claim 11,
wherein the first machine housing segment and the second machine housing segment are reversibly detachably connected to one another.

14. The machine housing according to claim 11,
wherein the first machine housing segment and the second machine housing segment are configured as respective cast parts.

15. The machine housing according to claim 11,
wherein, in each case, one of the machine housing segments has an end shield for the respective E-machine to be mounted in the respective other machine housing segment.

16. The machine housing according to claim 11,
wherein the first machine housing segment has a first sealing surface region, and the second machine housing segment has a second sealing surface region, which together form a circumferential sealing surface when the machine housing segments are connected together.

17. The machine housing according to claim 11,
wherein at least one of the first or second machine housing segments has at least one transmission housing part configured to receive a transmission shaft that can be driven by at least one of the E-machines.

18. A motor vehicle comprising:
the machine housing according to claim 11.

19. A method of manufacturing a machine arrangement with a machine housing comprising:
providing a first machine housing segment of the machine housing, a second machine housing segment of the machine housing, a first E-machine, and a second E-machine;
inserting the first E-machine into the first machine housing segment and thereby producing a first E-machinemachine housing segment assembly;
inserting the second E-machine into the second machine housing segment and thereby producing a second E-machinemachine housing segment assembly;
rotating at least one of the first or second E-machine-machine housing segment assemblies relative to the other E-machinemachine housing segment assembly; and
joining the first E-machine-machine housing segment assembly and the second E-machine-machine housing segment assembly, thereby completing the machine arrangement and the machine housing.

20. The method according to claim 19, comprising:
inserting the first E-machine into the first machine housing segment along a first insertion direction; and
inserting the second E-machine into the second machine housing segment along a second insertion direction oriented at least substantially in a same direction as the first insertion direction.

21. A motor vehicle comprising:
a machine arrangement manufactured in accordance with the method according to claim 19.
